(19) United States
(12) Patent Application Publication
(10) Pub. No.: US 2025/0340104 A1
(43) Pub. Date: Nov. 6, 2025

(54) RECREATIONAL VEHICLE WITH A ROOF SHELL

(71) Applicant: Dethleffs GmbH & Co. KG, Isny im Allgäu (DE)

(72) Inventors: Herr Erik Plischke, Missen-Willhams (DE); Herr Thomas Schuster, Hergenweiler (DE); Herr Norbert Mösle, Lautrach (DE); Herr Roland Sauter, Aitrach (DE)

(21) Appl. No.: 18/654,121

(22) Filed: May 3, 2024

(51) Int. Cl. B60J 10/36; B60J 10/90; E05F 15/00

(52) U.S. Cl. CPC B60J 10/365; B60J 10/90; E05F 15/00; E05Y 2900/512; E05Y 2900/542

(57) ABSTRACT

A roof shell, which is preferably designed as an adjustable roof shell, is used for recreational vehicles, in particular for mobile homes or caravans. The roof shell has an outer shell, an inner shell and a foam core. The outer shell is made of a deep-drawn thermoplastic. Furthermore, a recreational vehicle with such a roof shell is specified.

The invention relates to a recreational vehicle with a roof shell, particularly an adjustable roof shell. In particular, the invention relates to the field of recreational vehicles designed as mobile homes or caravans.

A camping vehicle with a vehicle roof is known from DE 10 2021 103 413 A1. It is known that vehicle roofs, for example sleeping roofs, pop-up roofs, lifting roofs, sliding roofs or high roofs, are realized in a sandwich construction. It is further known that frequently used materials include aluminum, expanded polystyrene (EPS), extruded polystyrene (XPS), polyurethane (PU), wood or glass fiber reinforced plastic (GRP).

In the case of a roof shell made from a pressed aluminum sheet with correspondingly welded gusset plates for stiffening, the tool costs for the press are particularly high. Hand-laminated roof shells made of glass fiber-reinforced plastic, which are produced using the vacuum expansion process, have high production costs and a high weight. In addition, the roof structure can be partially unstable and difficult to rework. In addition, glass fiber-reinforced plastic cannot be recycled as it represents hazardous waste. This also results in high tool costs. Further, the design is inflexible and therefore generally not adaptable to other vehicle types. Both aluminum and glass fiber-reinforced plastics have the disadvantages in the production of the roof shell that they are not very flexible during post-processing and the realized constructions are heavy.

The object of the invention is to provide a roof shell for a recreational vehicle, particularly for a motorhome or caravan, and a recreational vehicle with a roof shell, which are of improved design.

The object is achieved by a recreational vehicle or roof shell with various combinations of the features of the appended claims.

The object is achieved by a roof shell, in particular an adjustable roof shell, for recreational vehicles, in particular for mobile homes or caravans, having an outer shell and at least one foam core, wherein the outer shell is at least partially formed from at least one thermoplastic.

The object is further achieved by a recreational vehicle, in particular a caravan or a motorhome with at least one such outer shell.

Advantageously, the outer shell can be formed at least substantially from at least one thermoplastic. A thermoplastic is also understood to be a thermoplastic terpolymer. This makes it possible to save weight. Further, manufacturing costs can be reduced and post-processing made possible.

Advantageously, the outer shell is formed at least partially from a polycarbonate (PC) and/or at least partially from a thermoplastic terpolymer, particularly an ABS plastic, and/or at least partially from a PMMA. An ABS plastic is a plastic based on an acrylonitrile-butadiene-styrene copolymer (ABS). A PMMA is understood to be a polymethyl methacrylate. Preferably, a substantial entirety, or at least a majority, of the outer shell is formed from such a thermoplastic. This makes it possible to manufacture the roof shell in a sandwich construction comprising a foam core sandwiched between a thermoplastic inner shell and a thermoplastic outer shell.

Advantageously, the foam core is formed at least substantially from an extruded polystyrene (XPS). The design of the outer shell and the foam core as well as an inner shell particularly allows for an advantageous adaptation of the sandwich structure with regard to the thermal and static requirements.

It is also advantageous that an inner shell connected to the outer shell is provided and that the foam core fills a substantial entirety of an intermediate space formed between the outer shell and the inner shell.

Thermal requirements in particular can be met here, wherein a lightweight construction is made possible.

It is further advantageous in this context that the outer shell and the inner shell form at least one edge protrusion and that the outer shell and the inner shell lie at least substantially against one another at the edge protrusion and are bonded together over their entire surface. This enables large-area bonding, so that high stability can be achieved with reduced manufacturing costs. Further, additional fastening means can be saved.

It is also advantageous in this context that the inner shell is at least partially formed from at least one ABS plastic. In particular, recyclability can be achieved in this way for both the outer shell and the inner shell. Further, lightweight construction can be made possible. Furthermore, tool costs can be realized within a manageable framework. Furthermore, the roof shell can be designed flexibly and adaptably for other vehicle types. In addition, the roof shell can be constructed in such a way that it already has a high inherent rigidity. It is therefore particularly advantageous that the outer shell, the foam core and the inner shell can be designed from very lightweight materials.

Further, at least one bead can be formed on the inner shell. This advantageous design has the advantage that additional bracing is possible. Conversely, this makes an even lighter design and more economical use of materials possible.

Furthermore, it is advantageous that the outer shell is at least partially formed from at least one thermoformed thermoplastic. Preferably, the thermoplastic is dyed with at least one external color before thermoforming. A co-extruded outer shell can be realized here in particular. If this is already dyed with the desired exterior color before thermoforming, it is less susceptible to scratches or the like. Depending on the design, however, the outer shell can also be painted. The inner shell can also be designed in the same way if this is possible according to the choice of material and is appropriate in the corresponding use case.

Further, suitable extensions can be made to the roof shell. In particular, the choice of material allows for particularly good post-processing capability, so that further elements can be assembled or attached. Photovoltaics can be realized in particular. A heated headliner can also be installed on the roof shell. Further, one or more panoramic windows can be designed on the roof shell.

Further advantages and details of the invention are explained in more detail with reference to the exemplary embodiments shown in the schematic figures.

In the figures:

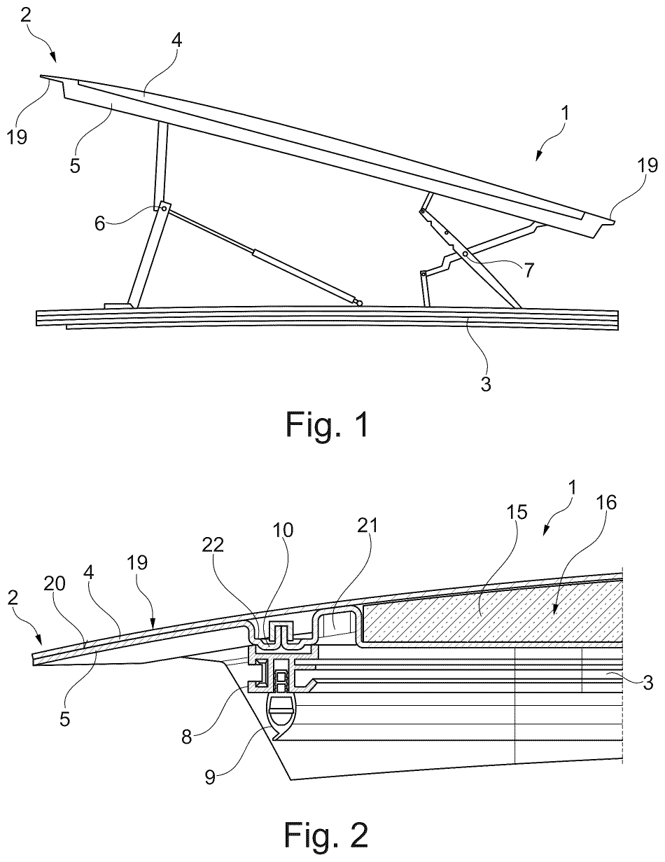

FIG. 1 shows an excerpt schematic diagram of a recreational vehicle with a roof shell according to an exemplary embodiment, wherein a view from the side is shown; and

FIG. 2 shows an excerpt, schematic diagram of the recreational vehicle with the roof shell in a schematic sectional view.

FIG. 1 shows a recreational vehicle 1 with a roof shell 2 in an excerpt-wise, schematic diagram according to an exemplary embodiment of the invention. Here, the roof shell 2 is represented as a whole, while a roof 3 of the recreational vehicle 1 is only shown in part from the side. The recreational vehicle 1 can be designed particularly as a motorhome or caravan. The roof shell 2 is particularly suitable for such leisure vehicles 1.

The roof shell 2 comprises a thermoplastic outer shell 4, a thermoplastic inner shell 5, and a foam core 15 sandwiched between and preferably contacting the thermoplastic inner shell 5 and the thermoplastic outer shell 4. In embodiments, the contact between the foam core 15 and the inner and outer shells 4, 5 immobilizes the foam core within the roof shell 2, to enhance the structural integrity of the roof shell 2. The roof shell 2 is connected to the roof 3 of the recreational vehicle via an active set-up kinematic 6 and a passive set-up kinematic 7. As is illustrated in FIG. 1, the active set-up kinematic 6 and the passive set-up kinematic 7 are configured to transition the roof shell 2 between a closed state, where the roof shell 2 is supported on a bearing surface of the vehicle roof 3, and an open state, where the roof shell is elevated relative to the bearing surface of the vehicle roof 3 to form an opening in the vehicle roof.

In the following, the design of the roof shell 2 is also described with reference to FIG. 2.

FIG. 2 shows the roof shell 2 shown in FIG. 1 in an excerpt-wise, schematic sectional view, wherein a section in the front area of the vehicle is shown. In FIG. 2, the roof shell 2 is shown in the closed state. Collectively, the roof shell 2, profile 8, and the main seal 9 form a weatherproof seal when the roof shell 2 is in the closed state.

The roof shell 2 has a foam core 15. An intermediate space 16 is formed between the outer shell 4 and the inner shell 5. The foam core 15 fills a substantial entirety of the intermediate space 16. The outer shell 4 and the inner shell 5 contact each other to form an edge projection 19 along a periphery of the roof shell 2. In a modified design, several edge projections can also be provided. At the edge projection 19, the outer shell 4 and the inner shell 5 rest against each other, which takes place on a contact surface 20. The outer shell 4 is bonded to the inner shell 5 over a large area at the contact surface 20. During mounting, the inner shell 5 may already have the final supports and the adhesive surfaces.

Further, the inner shell 5 has at least one profile discontinuity that forms an interior rib 21 along substantially an entire periphery of the inner shell 5. This interior rib 21 provides additional stiffness to the structure. In principle, the inner shell 5 can also have at least one sealing bead 10 formed along substantially an entire periphery of the inner shell 5 to enhance the aforementioned weatherproof seal with the roof 3 of the recreational vehicle. The sealing bead 10 is surrounded peripherally by the edge projection 19 formed by the thermoplastic outer shell 4 and the thermoplastic inner shell 5 to further enhance the integrity of the roof shell 2. The sealing bead 10 may comprise one or more bead-shaped protrusions 22 to optimize contact with the profile 8. In the illustrated embodiment, the foam core 15 is surrounded peripherally, in its entirety, by the interior rib 21, which is surrounded peripherally, in its entirety, by the sealing bead 10, which is surrounded peripherally, in its entirety, by the edge projection 19.

The outer shell 4 can be coextruded from PC and/or an ABS plastic and/or a PMMA. Preferably, the outer shell 4 already has the finished outer color before deep drawing. The selected thermoplastic is colored before thermoforming.

The inner shell 5 is preferably produced from an ABS plastic, preferably by thermoforming. The foam core 15 is preferably designed as an XPS foam core. The foam core 15 can thus serve to insulate and additionally reinforce the shells 4, 5. The roof shell 2, realized as a sandwich shell, can thus be adapted with regard to the thermal and structural requirements by selecting the materials used and the structural design.

The invention is not limited to the embodiments described.

1. A recreational vehicle comprising a roof and an adjustable roof shell connected to the roof of the recreational vehicle via an active set-up kinematic and a passive set-up kinematic, wherein:
the active set-up kinematic and the passive set-up kinematic are configured to transition the roof shell between a closed state, where the roof shell is supported on a bearing surface of the vehicle roof, and an open state, where the roof shell is elevated relative to the bearing surface of the vehicle roof to form an opening in the vehicle roof; and
the roof shell comprises a thermoplastic outer shell, a thermoplastic inner shell, and a foam core sandwiched between the thermoplastic inner shell and the thermoplastic outer shell.

2. The recreational vehicle as claimed in claim 1, wherein:
the thermoplastic outer shell and the thermoplastic inner shell contact each other to form an edge projection along a periphery of the roof shell; and
the thermoplastic outer shell is bonded to the thermoplastic inner shell along the edge projection.

3. The recreational vehicle as claimed in claim 2 wherein the foam core is surrounded peripherally, in its entirety, by the edge projection.

4. The recreational vehicle as claimed in claim 2 wherein the bond between the thermoplastic outer shell and the thermoplastic inner shell is an adhesive bond.

5. The recreational vehicle as claimed in claim 2 wherein the bond between the thermoplastic outer shell and the thermoplastic inner shell extends along a substantial entirety of the periphery of the roof shell.

6. The recreational vehicle as claimed in claim 5 wherein the thermoplastic inner shell comprises a sealing bead formed along substantially an entire periphery of the inner shell.

7. The recreational vehicle as claimed in claim 6 wherein the sealing bead is surrounded peripherally by the edge projection formed by the thermoplastic outer shell and the thermoplastic inner shell.

8. The recreational vehicle as claimed in claim 7 wherein the foam core is surrounded peripherally, in its entirety, by the sealing bead and the edge projection.

9. The recreational vehicle as claimed in claim 5 wherein the thermoplastic inner shell comprises a profile discontinuity that forms an interior rib along substantially an entire periphery of the inner shell.

10. The recreational vehicle as claimed in claim 9 wherein the interior rib is surrounded peripherally by the edge projection formed by the thermoplastic outer shell and the thermoplastic inner shell.

11. The recreational vehicle as claimed in claim 10 wherein the foam core is surrounded peripherally, in its entirety, by the interior rib and the edge projection.

12. The recreational vehicle as claimed in claim 5 wherein:
the bond between the thermoplastic outer shell and the thermoplastic inner shell extends along a substantial entirety of the periphery of the roof shell;
the thermoplastic inner shell comprises a sealing bead formed along substantially an entire periphery of the inner shell;
the thermoplastic inner shell comprises a profile discontinuity that forms an interior rib along substantially an entire periphery of the inner shell; and
the foam core is surrounded peripherally, in its entirety, by the interior rib, which is surrounded peripherally, in its entirety, by the sealing bead, which is surrounded peripherally, in its entirety, by the edge projection.

13. The recreational vehicle as claimed in claim 1 wherein the foam core is sandwiched between and contacts the thermoplastic inner shell and the thermoplastic outer shell.

14. The recreational vehicle as claimed in claim 13 wherein the contact between the foam core and the thermoplastic inner shell and the thermoplastic outer shell immobilizes the foam core within the roof shell.

15. The recreational vehicle as claimed in claim 13 wherein the foam core fills a substantial entirety of an intermediate space formed between the outer shell and the inner shell.

16. The recreational vehicle as claimed in claim 1 wherein:
a substantial entirety of the thermoplastic outer shell and the thermoplastic inner shell is formed from a thermoplastic material; and
the foam core is formed from an extruded polystyrene.

17. The recreational vehicle as claimed in claim 1 wherein:
at least a majority of the thermoplastic outer shell and the thermoplastic inner shell is formed from a thermoplastic material; and
the foam core is formed from an extruded polystyrene.

18. The recreational vehicle as claimed in claim 1 wherein the outer shell, the inner shell, or both, are formed at least partially from a polycarbonate, a thermoplastic terpolymer, an acrylonitrile-butadiene-styrene copolymer plastic, polymethyl methacrylate, an acrylonitrile-butadiene-styrene copolymer plastic, or combinations thereof.

19. A recreational vehicle comprising a roof and an adjustable roof shell connected to the roof of the recreational vehicle via an active set-up kinematic and a passive set-up kinematic, wherein:
the active set-up kinematic and the passive set-up kinematic are configured to transition the roof shell between a closed state, where the roof shell is supported on a bearing surface of the vehicle roof, and an open state, where the roof shell is elevated relative to the bearing surface of the vehicle roof to form an opening in the vehicle roof;
the roof shell comprises a thermoplastic outer shell, a thermoplastic inner shell, and a foam core sandwiched between the thermoplastic inner shell and the thermoplastic outer shell;
the foam core is sandwiched between and contacts the thermoplastic inner shell and the thermoplastic outer shell;
the contact between the foam core and the thermoplastic inner shell and the thermoplastic outer shell immobilizes the foam core within the roof shell;
the foam core fills a substantial entirety of an intermediate space formed between the outer shell and the inner shell;
the thermoplastic outer shell and the thermoplastic inner shell contact each other to form an edge projection along a periphery of the roof shell;
the thermoplastic outer shell is bonded to the thermoplastic inner shell along the edge projection;
the bond between the thermoplastic outer shell and the thermoplastic inner shell extends along a substantial entirety of the periphery of the roof shell;
the thermoplastic inner shell comprises a sealing bead formed along substantially an entire periphery of the inner shell;
the thermoplastic inner shell comprises a profile discontinuity that forms an interior rib along substantially an entire periphery of the inner shell;
the foam core is surrounded peripherally, in its entirety, by the interior rib, which is surrounded peripherally, in its entirety, by the sealing bead, which is surrounded peripherally, in its entirety, by the edge projection.

20. The recreational vehicle as claimed in claim 19, wherein:
a substantial entirety of the thermoplastic outer shell and the thermoplastic inner shell is formed from a thermoplastic material; and
the foam core is formed from an extruded polystyrene.
